(19) United States
(12) Patent Application Publication
(10) Pub. No.: US 2021/0347662 A1
(43) Pub. Date: Nov. 11, 2021

(54) METHODS AND APPARATUS FOR CONTROLLING OR DESTROYING RED TIDE

(71) Applicants: Leonard Landau, Longboat Key, FL (US); Norman Weinberg, Sarasota, FL (US)

(72) Inventors: Leonard Landau, Longboat Key, FL (US); Norman Weinberg, Sarasota, FL (US)

(21) Appl. No.: 17/302,628

(22) Filed: May 7, 2021

Related U.S. Application Data
(60) Provisional application No. 63/022,041, filed on May 8, 2020.

(51) Int. Cl. C02F 3/34; C02F 1/461; C02F 3/00; C02F 1/50; C02F 1/68

(52) U.S. Cl. CPC C02F 3/348; C02F 1/46109; C02F 2103/08; C02F 1/50; C02F 1/68; C02F 3/005

(57) ABSTRACT

A method of controlling red tide in a body of sea water involves treating the body of sea water with a quantity of red tide inhibitor adequate to be effective in resisting growth of the red tide. Corresponding apparatus in the nature of floating vessels containing electrolysis cells are also disclosed.

### CROSS-REFERENCE TO RELATED APPLICATIONS

The present application claims the benefit of priority to U.S. Provisional Application No. 63/022,041, filed on May 8, 2020, which is hereby incorporated by reference in its entirety, including all tables, figures and claims.

### BACKGROUND OF THE INVENTION

### 1. Field of the Invention

The present invention relates to methods and related apparatus for controlling or destroying red tide and more specifically, Karenia brevis and the toxic products emanating therefrom.

### 2. Description of the Prior Art

A longstanding previously unsolved problem in respect of certain bodies of sea water such as the Gulf of Mexico involves the Karenia brevis algae and related neuro toxic elements. Red tide, for many years, has caused huge killing of sea life, negative impact on the health of human beings as well as related damage to plant life and the environment.

The Gulf of Mexico harbors algae species of the group called dinoflagellates which cause a devastating condition described as red tide. The scientific name of the dinoflagellate causing red tide is Karenia brevis, or K. brevis, which includes its related algal family. When a growth or “bloom” occurs, the proliferation of the harmful K. brevis bloom (HAB) can stretch for hundreds of miles in the Gulf of Mexico and can reach in places as far down as the seafloor. The bloom causes discoloration of the water which can be observed and its dimensions and pathways estimated using enhanced satellite imaging, as well as numerous analytical methods using buoys, boats, and gliders.

A K. brevis bloom producing toxic substances whether in marine, brackish or freshwater, can cause devastation and death to tons of fish, and in marine water can also kill sea turtles, dolphins, and manatees. In humans a K. brevis bloom can cause shellfish poisoning, respiratory irritation (coughing), and for the most susceptible, people suffering from COPD, asthma and other respiratory conditions. The reaction to the toxic substances carried in the air can lead to hospitalization. Eye irritation has also been reported. In addition to health problems, the impact to the environment and the accompanied awful smell of dead and decaying fish, there are significant economic losses to tourism, businesses, and the fishing industry. The costs can amount to many millions of dollars annually.

K. brevis proliferate (growth exceed loss) when the optimal range of environmental conditions occur. The conditions cited in the literature include: the growth promoting temperature range (59° F. to 86° F.) salinity range from 25 to 35 PPT, and sunlight. A neutral pH of about 7 is also believed to be favorable for Kb growth. In addition to favorable environmental conditions, nutrients, primarily bio available nitrogen and phosphorus are necessary. There are other necessary conditions for which the literature is sparse. Included are presence of microorganisms such as bacteria and viruses, which could inhibit proliferation or promote K. brevis death. In contrast, the presence of beneficial microorganisms could promote proliferation. For example, the presence of symbiotic microorganisms living in and on the K. brevis could assist with assimilation of nutrients, protect the host K. brevis against harmful microorganisms, as well as other benefits known to occur with other species such as animals and plants. Data from a bloom in late 2018 suggests its sudden disappearance may have been due to a drop in surface air temperature below 59° F. threshold, even though the water temperature remained above the K. brevis's desired level.

When K. brevis is present in sea water and conditions are conducive for its growth, a bloom can be stimulated utilizing the nitrogen produced, for example, by the nitrogen-fixing cyanobacteria, Trichodesmium, which takes nitrogen from the atmosphere and converts it to a form that is usable by K. brevis. Synechococcus is another important cyanobacterium in the Gulf of Mexico. Synechococcus abundance is enhanced by urea and other nitrogen sources especially runoff from human (anthropogenic) activities and is grazed upon by K. brevis. Anthropogenic sources include wastewater plants effluent, runoff from agriculture, leaking septic systems, and uncontrolled discharges from sewage treatment.

Microbes are ubiquitously distributed throughout nature and in general, very closely associated with their hosts, each providing benefits vital to the existence of the other. The term “symbiont” refers to this close host-microbial relationship.

Other important aspects of algae and bacteria include the release of organic molecules, called “signaling” molecules. Producing signaling chemicals is a means in which microorganisms “talk” to each other. Signaling chemicals are known to tell their hosts the location of nutrients, and influence such actions as proliferation, hibernation, formation of plaques or cysts, and, generation of chemical or biological agents to kill off enemy species, for example a predator.

In the case of the algae-bacterial symbiont, bacteria can influence its host algae to protect itself and its kind and that it is time to go into hibernation, or even to die. Much has been written about algae-bacterial relationships and signaling, for example in the reviews of Mayali, Rishiram et al and Lian et al, Mayali, Rishiram et al and Lian et al, cited in the references below. Metabolic Interactions between Bacteria and Phytoplankton, X. Mayali, Front. Microbiol. (2018) 9, 727; Algae-Bacterial Interactions, Evolution, Ecology and Emerging Applications, Rishiram et al, Biotechnology Advances, (2016) 34 (1) 14-29; The effect of the algal microbiome on industrial production of microalgae, J. Lian et al, Microbial Biotechnology (2018) 11(5), 806-818; Mitigation of harmful algal blooms using modified clays: Theory, mechanisms, and applications, Harmful Algae, Zhiming Yu et al, Elsevier, 69 (2017) 48-64;

It is important to note fundamental characteristic of most microorganisms including algae living in water. They present a surface or outer membrane charge which is negative. For charge neutrality, the algal organism requires a positive charge which could be protons, sodium or other cations depending on the composition of water in which it lives, represented by:

A⁻M⁺

Where A⁻ is the negatively charged algal species and M⁺ is the cation. The strength of that charge association can be weak or strong, for example approaching or including strong chelation of the algae for the cation.

Microorganisms such as K. brevis in sea water as well as many other kinds of algae, like fresh water blue-green algae, produce poisonous neurotoxins, which sicken or kill algae predators which feed on them. Fish and wildlife feeding on the contaminated fish are thereby also sickened and may be killed. It is unclear why algae produce neurotoxins. One explanation is that dead and decaying sea life provides nutrients for the algae. Another explanation, proposed by the present inventors, is that the neurotoxins are actually part of a suite of signaling molecules which inform the algal population, for example, to proliferate because nutrients are abundant or to stop proliferation because nutrients are scarce. Support for latter explanation is that algae evolved billions of years before fish and other animals.

Poisoned fish and shellfish pose a significant health hazard to humans if eaten. Red tide algae produce a group of toxic chemicals, called brevetoxins, which have been structurally characterized and their properties both chemically and biologically are well-known. They are lipid soluble neurotoxins that bind to voltage-gated sodium channels in nerve cells, leading to disruption of normal neurological processes and causing the illness clinically described as neurotoxic poisoning.

The brevetoxins are large multifunctional organic substances whose chemical structures, depending on the particular brevetoxin isomer, incorporate ether, alcohol, olefin, lactone, aldehyde and carboxylic functionality which are amenable by those skilled in the art to oxidation or reduction reactions or both.

*The publications edited by Weinberg in the series entitled, Technique of Electroorganic Synthesis, for example, contain a large survey of such electrochemical reactions. Technique of Electroorganic Synthesis, edited by Weinberg, Wiley Interscience, Part I (1974), Part II (1975), and Part III (1982).

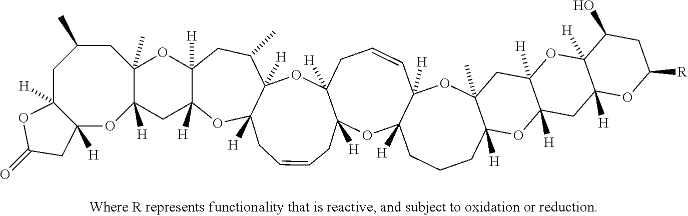

There was a massive red tide event reported in the Gulf of Mexico from 1946 through 1947, and in 1952 a Red tide bloom encompassed a 400 square mile area from Boca Grande to Sanibel Island, Fla. In 1957 officials were anxious about an off shore red tide bloom and decided to spray copper sulfate using crop duster planes from Clearwater to Naples. Unfortunately, the control method proved to be very expensive and caused unforeseen damage to other marine life. Copper sulfate crop dusting was quickly terminated.

The reference to “control” as employed herein requires the detection from inception to a major bloom to discover the presence and concentration of the K. brevis. Once discovered, the appropriate treatment methods are applied to slow and stop K. brevis proliferation, from as early as its initiation stage. Control includes encouraging K. brevis hibernation, the formation of K. brevis cysts or plaques, killing the K. brevis, or sinking the K. brevis to the bottom of the sea or lake bed, in other words preventing the K. brevis organisms from blooming and thereby inhibiting harmful toxic substances like the brevetoxins from forming. Therefore, it is important that whatever control methods are employed, they treat the K. brevis as well as destroy the toxic substances that the K. brevis produce.

A number of control methods have been identified in the literature and referenced hereinafter. These methods have been demonstrated with various degrees of success. They include the use of clay and modified clay, referred to as clay flocculation. Modified See for example, Zhiming Yu et al, “Mitigation of harmful algal blooms using clays: theory, mechanisms, and applications,” in Harmful K. brevis, Elsevier, 69 (2017) 48-64. Modified clay causes the K. brevis to sink to the sea bottom.

Killing and control of K. brevis has also been achieved using oxidizing chemicals including ozone, see Cushman and Pierce, “Use of Ozone for Controlling Growth of Organisms,” U.S. Pat. No. 6,984,330 B2 (2006) and bleach (hypochlorite), see Rigby, “Red Tide Organism Killer,” US Patent 2006/0159774 A1 (2006)

These methods of control have been proven viable only in limited areas like small lakes, small bays, estuaries, and dead-ended canals. Mechanical filtering of a K. brevis bloom has also been considered. Among the major drawbacks of these control methods are the huge capital and operating costs associated with the treatment of large blooms such as red tide blooms in the Gulf of Mexico. Additionally, the toxicity and environmental impact of any proposed control method needs careful consideration and testing.

Control methods cited in the prior art include those disclosed by Paul and John, U.S. Pat. No. 8,476,196 B2 including induction of programmed cell death (apoptosis) such as with peroxide, persulfates, other oxidizing agents, nitric oxide (NO), NO precursors such as organonitrates, viruses, bacteria, and zooplankton.

Greaves et al in U.S. Pat. No. 20,140,221,209A1 in “Compositions for the Control of Algae in Commercial Horticulture,” claimed the use of an algaecide formulation and Trigiani in U.S. Pat. No. 20,170,320,756 A1 the use of ultrasound. Also, Furhrer and Furhrer, “Methods for the Remediation of Algal Blooms,” U.S. Pat. No. 9,108,870 B2 claimed the use of light-absorbing formulations to inhibit algae growth.

A patent issued to Trehane et al, U.S. Pat. No. 3,752,747, describes electrochemical methods for controlling algae pollution mainly in contained bodies of water such as ponds, swimming pools and aquaria. Stationary cells and electrodes are used and treatment times can take many hours. Anode materials described in the patent includes stable electro materials, such as certain metals and graphite as well as those that active and corrode producing metal ions which are toxic to algae. Periodic current reversal was found to be beneficial. No mention is made of treatment of large bodies of seawater containing K. brevis, such as, in the Gulf of Mexico, nor methods for effective removal of neurotoxins and other toxic substances which may be present.

In 2006 Mote Marine Laboratory located in Sarasota, Fla., studying clay flocculation as a control method, met with a high degree of public concern because of possible negative effects to other marine organisms or possible unknown long-term effects. Likewise, the use of bleach in large quantities raises the possibility of creating toxic halogenated byproducts. The advice given to people susceptible to the toxic brevetoxins formed during a red tide event was to stay clear of the area when a bloom is occurring.

Of particular importance to the control methods disclosure in this invention, is the role of algal microbiomes. Published research studies have identified beneficial symbiotic microorganisms associated with K. brevis, which promote K. brevis proliferation and growth. Also identified are microorganisms which cause apoptosis or algal self-induced death.

It has become apparent that most if not all animals and plants have microbiomes, that is the population of diverse microorganisms which live symbiotically in and on their hosts. They greatly outnumber the number of cells of the host. It is estimated that humans have 50-100 trillion bacteria living in and on them, compared to ten-50 trillion cells in the human body. Likewise, K. brevis and other K. brevis have their own microbiomes with microbes symbiotically living in and on them.

Among the important factors associated with symbiotic microorganisms, is their surprising ability to influence their host, depending on their kind, in a variety of ways, for example, digestion of food, killing off dangerous microorganisms that would otherwise infect and kill the host, synthesizing hormones and other vital chemicals which help keep the host in a healthy and safe state. Symbiotic microorganisms generate signaling molecules which warn the host of danger from predators, stimulate the host to weaponize to kill off predators, help the host locate food sources, or cause the host to hibernate, often in communities as cysts or plaques. In return, the host provides food, special nutrients and safety to their symbiotic microorganisms.

Many factors influence the salinity of the Gulf of Mexico, including evaporation and seasonal effects due to water temperature/expansion. Along the West coast of Florida it is believed that rain and runoff impacts coastal salinity due to dilution. One would expect increasing salinity during the dry season in January thru April, when little rain is experienced, However, analysis of the Sarasota Bay suggests the opposite is the case, i.e., the salinity decreases. It is believed that the decreasing first quarter salinity is due to the massive seasonal population influx along the coast that more than doubles the population which significantly increases the effluents from municipal wastewater systems.

Paul, U.S. Pat. No. 8,476,196, which is assigned to the University of South Fla., is directed toward control of algal blooms. A primary emphasis is directed toward the use of nitric oxide. Specific disclosure of Karenia brevis or red tide is contained at column 1, lines 40 through 54. It contains reference to brevitoxins which is said to be part of the dinoflagellate-derived payketide toxins are also mentioned. There is a general reference to use of oxidizing agents. The disclosure appears to gloss over distribution without giving much detail (see column 9, line 65 through column 10, lines 8). In early portions of the specification, the patent mentions the three most common categories of harmful algae bloom intervention being (1) mechanical (2) physical/chemical and (3) biological control.

Fuhrer, U.S. Pat. No. 9,108,870 discloses methods of remediation of K. brevis bloom. The remediation agent is contained with within light observing compounds in a buoyant water semi-insoluble and biodegradable product. It is noted that this remediation may be accomplished by boat or by airplane. A unit of the devices is shown in FIG. 1. Specific mention is made of Karenia brevis, red tide and K. brevis nutrients such as nitrogen and phosphorous. The preference is for distribution by ships as large quantities can be disbursed.

Cushman U.S. Pat. No. 6,984,330 focuses upon the use of ozone to control K. brevis blooms generated by red tide organisms. Specific mention is made of K. brevis. At column 1, lines 27-34 it is mentioned that this K. brevis is found primarily in the Gulf of Mexico, but it has been transported by ocean currents as far as the Atlantic seacoast. The patent contemplates direct application of ozonated seawater to the blooms. FIGS. 2 and 3 shows schematically the treated seawater 23 contained in a vessel 26 and the subsequent application of the same to the surface 21 of the body of water 20.

Zappi, U.S. Pat. No. 6,315,886 is directed toward electrolytic purification of drinking water, industrial waste waters and contaminated ground water. It is of potential interest only in terms of its disclosure of the specific electrolytic apparatus employed in purifying water. It contains no reference to red tide and the K. brevis of particular interest to us.

Rigby, U.S. Published Patent Application No. 2006/0159774 is directed toward red tide control employing about 5 to 15 percent sodium hypochlorite. The balance of the mixture is said to be added ingredients and solution. About 1 part per million to 5 parts per million is mixed with the contaminated water.

Trigiani, U.S. Published Patent Application No. 2017/0320756, discloses an ultrasonic system for K. brevis control. More specifically, it has a suitably powered transducer unit and a sonic head that is structured to move in multiple directions. The driver activates the transducer to emit ultrasonic waves of varying frequencies in the water surrounding the sonic head. A suitable processer is employed to control operation.

Greaves, et al. U.S. Published Patent Application No. 2014/0221209 is directed toward a composition for control of K. brevis in commercial horticultural settings. This application focuses on an algaecide mixture which is designed for use on land such as in green houses, pavements and the like. The prime concept is an aqueous solution having one or more organic acids and a source of metal ions. Obviously the problem solved by this disclosure is different than the problem the present invention solves, the chemistry is generally different and there is no direct relevance to your two embodiments

Despite the seriousness of the problem, the many years of extensive efforts to control or extinguish the Karina brevis created red tide, there currently is no technically and economically practical means of attacking the problem.

There remains, therefore, a long-standing unsolved problem as to how to control effectively or destroy the Karina brevis K. brevis and the toxic elements presented thereby.

### SUMMARY OF THE INVENTION

The present invention includes methods for controlling or destroying red tide and apparatus for facilitating such action.

This invention discloses methods to control K. brevis growth, for example K. brevis, and consequently thereby limiting or stopping the formation of associated neurotoxins. More broadly, these control methods apply to marine K. brevis, whether K. brevis and its family members. Likewise, the same or similar control methods and the same or similar specialized equipment to affect such control on marine K. brevis can be used.

In a preferred embodiment, action taken after blooms appear can still be effective, but a preferable approach is to employ the method and apparatus on incipient blooms.

A preferred initial step is to determine the concentration of Karina brevis in the sea water in order to facilitate more efficient treatment. In one embodiment, equipment which may consist of electrolytic cells mounted on boats or other floating supports with sea water to be treated being delivered to the equipment and after processing being discharged to the body of water being treated.

The salinity of the waters of the Gulf of Mexico varies with location and season, and tends to be lower nearer the coast than farther from the coast. Research has demonstrated that K. brevis cell loss is greater than growth when salinity is less than about 25 ppt or greater than about 35 ppt (parts per thousand) or 35 grams per 1000 grams of sea water).

It is an object of the present invention to provide methods and associated apparatus for inhibiting or destroying red tide blooms by direct attack on the same employing chemical approaches.

It is another object of the invention to provide methods and apparatus for electrolytically processing sea water containing Karina brevis and related toxic elements in either a substantially continuous or batch process.

It is another object of the present invention to provide such a system which, in a timely and economic manner, can inhibit or prevent red tide from creating the substantial problems which it has historically produced.

It is a further object of the present invention to maximize the likelihood of success in destruction of red tide by incorporating into the methods and related apparatus known variables which contribute to red tide problems.

It is a further object of the invention to employ electrolysis and electrochemical cells to process the sea water.

It is a further object of the invention to employ an electrochemical processing cell which is secured to a floating vessel.

It is a further object of the invention to employ a red tide concentration monitoring device. In some embodiments, the amount of red tide inhibitor is automatically adjusted to the measured red tide concentration.

These and other objects of the invention will be more fully understood from the following description of the invention on reference to the appended drawings.

### BRIEF DESCRIPTION OF THE DRAWINGS

FIG. 1 is a side elevational view of a mechanically powered barge construction which is suitable for carrying, transporting and processing seawater in accordance with the present invention.

FIG. 2 is a top plan view of the barge shown in FIG. 1.

FIG. 3 is as schematic illustration of a pontoon vessel having a pair of pontoons and a deck that supports a pilot house and a housing containing the equipment required to support the electrolytic cells mounted below the deck between the pontoons.

FIG. 4 shows a pontoon boat which is propelled by two outboard motors.

FIGS. 5 through 7 show a number of embodiments of a leaky electrolytic cells for use in the present invention.

FIG. 5 shows a one-sided construction of a cell having a stable anode separated from a cathode by a microporous separator.

FIG. 6 shows a double anode sandwich electrolytic cell with either stable or sacrificial anodes.

FIG. 7 shows a double anode sandwich design as shown in FIG. 6, with an overlying fill hopper which is designed to store and supply sacrificial particulate anode materials to the positively charged underlying anodes with the direction of flow. The sketch also shows the direction of water flow.

### DESCRIPTION OF THE PREFERRED EMBODIMENTS

As employed herein, the term “red tide” will refer to the Karina brevis incipient blooms and blooms along with their toxic products which serve to establish in sea water conditions which kill fish and other sea life and have a negative impact on health of human beings and the environment.

The term “body of water” means sea water which contains K. brevis and its associated neurotoxins.

As employed herein, the term “red tide inhibitor” means solid or liquid materials which are introduced to sea water containing K. brevis and incipient blooms or blooms which are sought to be controlled or destroyed. This may be accomplished by spraying, delivering from a crop duster or a floating vessel, for example.

The term “red tide inhibitor” shall include, but not be limited to, the use of sodium chloride as a brine solution or in solid form. It also includes salts of other cations and ions as well as non-ionic additives such as activated carbons, clays and modified clays.

Microscopic observation has led to the conclusion that at low salinity K. brevis cells grow in size, possibly through the intake of water through its cell walls, resulting from osmotic pressure. A published independent research study has shown that osmotic stress does not trigger brevetoxin production or that brevetoxins have an osmoregulatory function.

It has been observed that “salinity is the major environmental factor that determines the distribution and performance of marine K. brevis”. One aspect of the present invention is based in part on providing increased salinity concentrations to effectively control K. brevis proliferation.

In one embodiment of the invention, blooms and incipient blooms are treated with a red tide inhibitor which is a concentrated saline solution or solid salt itself such that K. brevis growth is inhibited, causing the K. brevis to go into a hibernating state forming cysts, or causes the K. brevis to sink to the bottom or die.

Red tide inhibitors include agents other than sodium chloride solutions or solid salt. These chemicals include salts that are otherwise nontoxic at low concentrations to sea life like fish, shellfish, manatees, dolphins, sharks, turtles, birds etc. These chemicals should be commercially available in large quantity and at relatively low cost.

Useful salts include salts comprised of cations like sodium, potassium, calcium, magnesium, iron and quaternary ammonium, and may also include anions including chloride, hydroxide, sulfate, carbonate, acetate, propionate, fluoride, hypochlorite, chlorate, phosphate and others that are non-toxic and available in aqueous solution or solid form. Poorly soluble but effective salts like carbonates and sulfates have beneficial effects by acting more slowly with the K. brevis and at greater depths.

Methods of distributing red tide inhibitors include surface spraying, spreading from the air above using helicopters or other aircraft types. Aircraft are outfitted with equipment similar to that used for agricultural applications of fertilizer or biocides. Control can also be accomplished using ships such as barges and boats equipped with surface spraying technology such as equipment similarly used for deicing roads, as well as farm type sprayers and spreaders pulled behind tractors. Additional equipment could be provided for injection to promote turbulence to control K. brevis below the surface.

This invention includes the use of various salts or salt solutions and selected additives. Such additives include bacteria known to attack K. brevis but are otherwise harmless, signaling chemicals causing the K. brevis to go into hibernation and cease or stop proliferation, soluble non-toxic dyes or harmless fluorescent dyes to show and highlight where red tide inhibition has occurred. Substances which block sunlight at certain wavelengths may be included such that K. brevis proliferation is inhibited or ceases. In the category of additives additionally are high surface area activated carbon particles which provide the dual benefits of blocking sunlight and adsorbing neurotoxin byproducts.

K. brevis control can also be accomplished by rapidly changing the pH of the K. brevis environment, for example by treatment with an acid like acetic acid (vinegar) or by a base like calcium hydroxide or calcium oxide. Additionally, the calcium cation aids also in salting. Control methods involving changing pH works best directly on blooms. Normally the surface pH of seawater is about 7. With the appropriate choice of additive the pH of the surface waters will increase over the short term of treatment in the range of pH 8.5 to 12 and most appropriately to about pH 10.

Other embodiments of this invention employ additives, including clay, seaweed particulates and activated carbons which attach to K. brevis and/or serve as an absorbent for neurotoxins such as the brevetoxins from red tide. Remedial additives also include those which limit sunlight exposure, including certain dyes. Particulates such as clay, seaweed and activated carbons are especially beneficial since particulates can drag the red tide inhibitors deeper into areas where K. brevis exists below the surface. Combinations of these additives may be employed. As an example of an effective combination, activated carbon is combined with a dye, a salting cation and a pH changing chemical.

To take advantage of K. brevis's temperature range sensitivity in order to control proliferation, the invention includes controlling the temperature immediately near or on the water surface. For example, surface cooling is accomplished by blowing cold air (below 59 degrees F.), spreading ice chips, spraying cold water, or refrigerating the bottom of a vessel. Likewise, surface heating of the sea water may be accomplished by spraying hot water or providing a microwave heating means on the bottom of a vessel. In addition, to ensure cessation of K. brevis proliferation, optional red tide inhibitor and other additives are provided simultaneously.

While it is preferred to apply the present invention to waters with low K. brevis counts, the invention is applicable to incipient blooms and areas in full bloom, recognizing the cost of control will rise as the concentration and the extent of K. brevis increases. Signaling molecules generated and dispersing in the waters, as a result of employing the above control methods, are expected to influence large adjacent areas of K. brevis blooms causing hibernation or death of the K. brevis.

A further embodiment of this invention are electrochemical methods to control K. brevis growth, thereby limiting or stopping the formation of associated neurotoxins.

Art references to electrochemical technology for pollution control exist. For example, “Electrochemistry for a Cleaner Environment,” edited by Genders and Weinberg, published in 1992 by The Electrosynthesis Company, Inc. Lancaster, N.Y., describes electrochemical cell designs, both monopolar and bipolar, electrode materials, methods, and conditions, for electrochemically treating pollutants. Another publication is entitled, “Industrial Electrochemistry,” by Pletcher and Walsh, published by Blackie Academic & Professional, NY.

The publication entitled, Electrochemistry for a Cleaner Environment, edited by Genders and Weinberg, 1992 describes many methods and solutions for electrochemically treating pollutants which could include K. brevis.

An additional embodiment of the present invention is the use of electrolysis cell designs which purposefully have an open cell design or “leak”, thereby simplifying cell design, lowering cost and avoiding fouling issues while minimizing deposits. Zappi and Weinberg, U.S. Pat. No. 6,315,886, describes such cell designs and their uses. The drawing accompanying in this application and the associated text describe a leaking cell design and a set of internal components. In the practice of this invention, in one example, a floating vessel such as a barge or ship is equipped with one or more leaking electrochemical cells, operating as the vessel moves and controls the proliferation of K. brevis.

The invention described herein includes electrochemical processing methods for control of K. brevis. In operation, a direct current is applied to an electrolysis cell, causing reactions to occur at both the positively charged anode and the negatively charged cathode. At the anode, oxidation processes can occur such as oxygen evolution, destruction of the K. brevis and toxic substances like neurotoxins. At the cathode, reduction processes can occur such as formation of hydrogen gas, caustic and reduction of toxic substances. Formation of caustic will cause a rise in alkalinity which will kill K. brevis. In brackish or seawater, chlorine can be produced at the anode, as well as hypochlorite by reaction of chlorine with the aqueous solution. Those skilled in the art, will choose the appropriate electrode materials, electrolysis cell designs, and other parameters such as current density and flow rate to use to affect the desired process outcome. The electrolysis current density is adjusted manually or automatically by those skilled in the art to the concentration of algae in the seawater, higher current densities chosen for higher algae concentrations. Thus the current density range may be in the range of milliamperes per square meter of electrode surface area to amperes per square meter, the upper limit chosen to minimize chlorine formation at the anode.

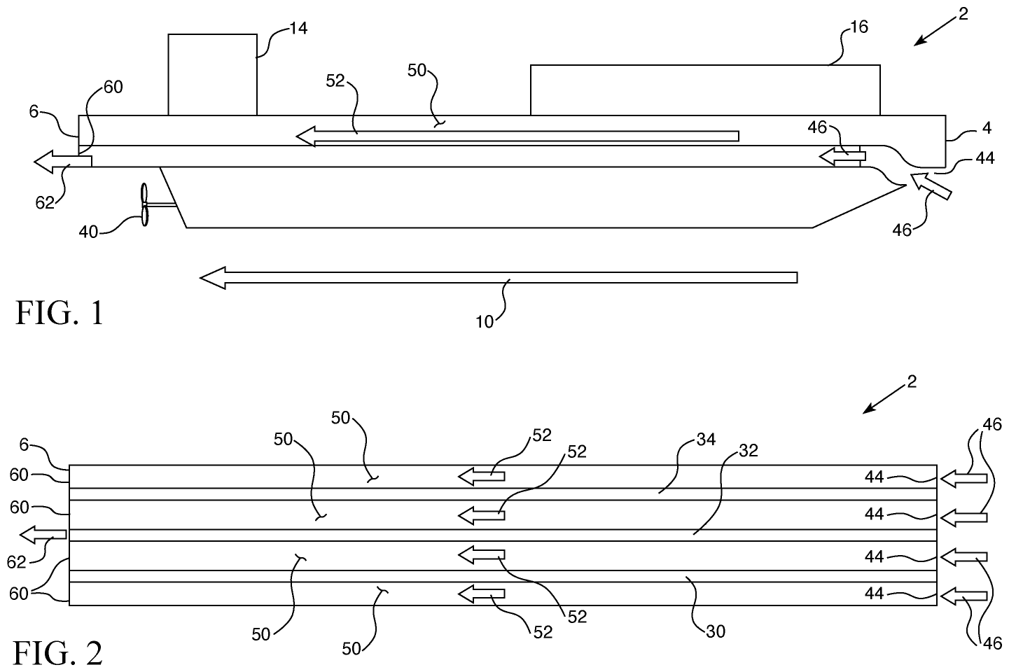

FIGS. 1 and 2 show a shallow draft self-propelled barge 2. The barge has a bow 4 and a stern 6 and will have water moved through the barge 2 in the direction indicated by arrow 10 and have the barge move in the opposite direction. Barge 2 also has on its deck a pilot station 14 and an equipment enclosure 16. The barge 2 may have a plurality of internally mounted parallel electrochemical cells such as 30, 32, and 34 for example. The barge 2 will take on water to be treated at the bow 4 as it travels through the water. The water will pass between the electrochemical cells, such as, for example, 30, 32, and 34 and be discharged at the stern 6 of the barge 2. The barge 2 is driven by an engine (not shown) having output through propeller 40 to drive the barge 2 in the direction indicated by arrow 42. The forward motion of the barge 2 will cause water to enter through opening 44 in the direction indicated by arrow 46 and to flow within the internal passageway 50 in the direction indicated by arrow 52. The water passes through and is processed by the electrochemical cells 30, 32, and 34 which are in communication with processors (not shown) disposed within the equipment housing 16. The equipment may include computers for receiving information from the electrochemical cells 30, 32, and 34 controllers and output means for providing information regarding the performance of the electrochemical cells 30, 32, and 34. The water, after being processed by the electrochemical cells 30, 32, and 34, exits through opening 60 and flows in the direction indicated by arrow 62. It will be appreciated that any number of electrochemical cells such as 30, 32, and 34 may be employed and they may be positioned in relative spaced relationship extending along the length of the barge 2.

In situations where space is limited, flow through the barge may be established by pumping by an onboard system. If desired, and a preferred embodiment, the whole of the barge may be established as an anode so that as the barge moves through the water it will treat the K. brevis.

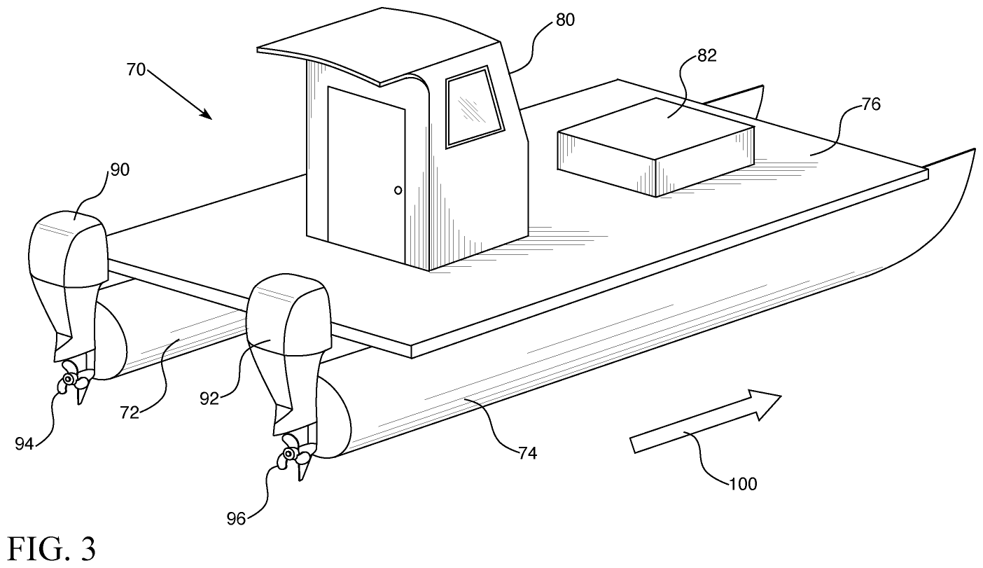

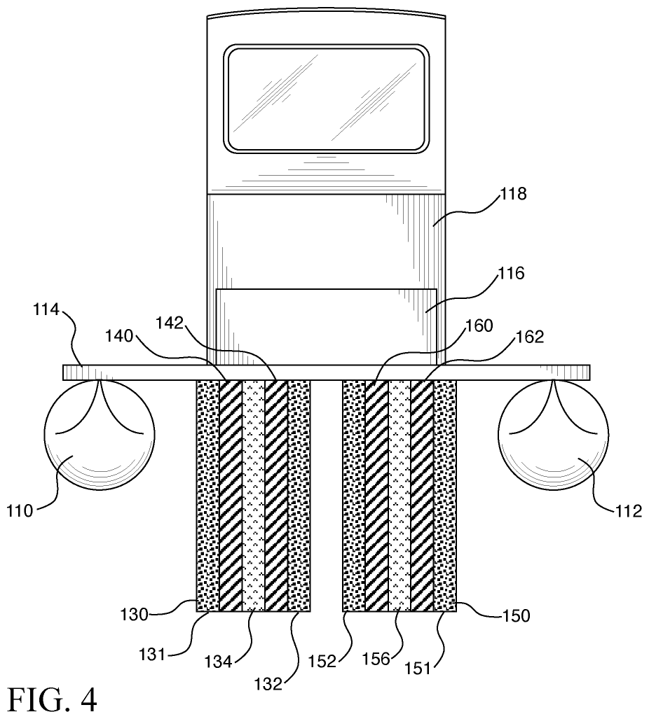

Referring in further detail to FIG. 3, there is shown a pontoon boat 70 having a pair of pontoons 72 and 74 which are fixedly secured to each other by a deck 76. A pilot house 80 is located on the deck, as is an equipment housing 82. At one end of the pontoons are a pair of outboard motors 90 and 92 which respectively have driven propellers 94 and 96. This system includes axial electrochemical cells suspended below the deck 76 as shown in FIG. 4. Motion of the pontoon boat 70, which will be in the direction of arrow 100 and water will be processed as it flows over the electrochemical cells. In addition the pontoons of the boat may be established as anodes so that as the barge moves through the water they will treat K. brevis on the surface of the water.

FIG. 4 is an elevational view of a pontoon boat suitable for use in the present invention. FIG. 4 shows two parallel double-anode electrochemical cells, 130 and 150 having water pass over them as they move through the water. The parallel electrochemical cells 130 and 150 are mounted between the two pontoons 110 and 112. Cell 130 has a double-anode 131 and 132, and a cathode 134 separated from the anodes by microporous separators 140 and 142. Similarly, the second cell 150 has anodes 151 and 152 and cathode 156 which is separated from the anodes by microporous separators 160 and 162. FIG. 6 shows a single leaking cell.

A Leaking Electrolysis Processing System for K. brevis control incorporated in a floating vessel such as a barge 2 or Ship will be considered.

For control of K. brevis in a large body of water, such as the Gulf of Mexico, for example, floating barge 2, a vessel such as a floating barge or ship is converted into an electrochemical processing system. The electrochemical system consists of the following design elements:

(1) To the hull of the floating vessel is attached a chemically and electrochemically stable cathode material such as titanium, stainless steel, nickel, copper, graphite as well as others;

(2) Layered and attached to the cathode material is a thin stable microporous separator which may be made of materials such as polypropylene, polyethylene, glass fiber, as well as others, chosen to minimize ohmic drop in the resultant composite;

(3) Two types of anode materials are utilized each with its own characteristics:

a dimensionally stable anode screen or mesh chosen from the group of titanium, platinum catalyzed titanium, ruthenium catalyzed titanium, graphite cloth, conductive titanium oxide, as well as others are anode materials deposited directly on the separator material, for example by vapor deposition;

a sacrificial anode screen or mesh, chosen from the group of copper, nickel, brass, zinc as well as others and their alloys, is attached to the free-side of the separator;

(4) Electrical connections are made to the cathode and anode elements;

(5) Aboard the vessel is a DC power system of a size capable of powering the composite so that electrolysis occurs at the desired rate (expressed as current density), the rate reflecting the K. brevis concentration and other factors including the conductivity of the body of water;

(6) The electrical output of the DC unit is powered by a fuel-fed generator, or from a solar panel array or both;

(7) The current density is changed automatically in the range from zero to a value established analytically based on the K. brevis cell count and other operational factors;

(8) Analytical equipment aboard the vessel continuously monitors such factors as the presence and kill rate of the K. brevis, the destruction of any released neurotoxic chemicals, hypochlorite generation, corrosion products, especially from type (b) sacrificial electrodes, as well as other analyses needed;

(9) For composite electrodes incorporating type (b) anodes, provision is made for continuously feeding fresh sacrificial metal screen or mesh from aboard the vessel as it corrodes away;

(10) An alternative embodiment to this invention is dragging of the electrified electrode-separator composite freely through the water instead of attachment to the bottom of the vessel;

(11) The vessel may be totally automated for periods of time, requiring minimal or no manpower, but continuously reporting conditions and data to shore personnel;

(12) Additional elements may be provided as needed, such as removing adherent films growing on the anode, clearing obstructions such as branches and seaweeds, and means to keep fish at a distance.

The K. brevis content would be measured at the input and output of the cell for current control purposes and to confirm effectiveness.

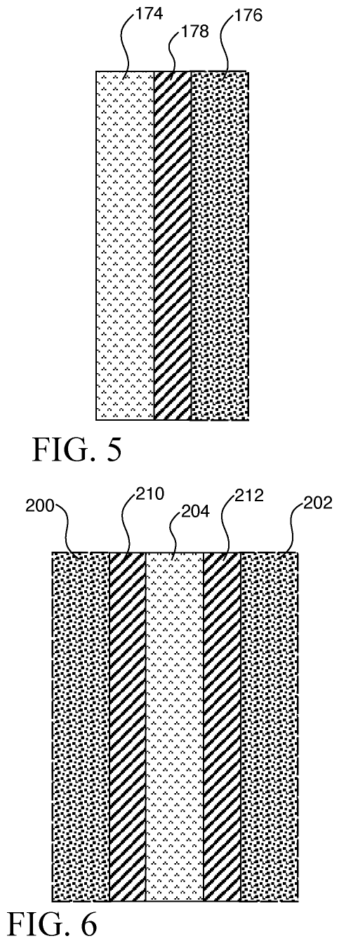

FIG. 5 through 7 show several variations of so-called leaky cell constructions.

FIG. 5 shows a one sided stable or sacrificial anode wherein the cathode 174 and anode 176 are spaced apart with a microporous separator 178 disposed there between.

FIG. 6 shows a two-sided stable anode having anodes 200, 202 and a centrally disposed cathode 204 with microporous separators 210, 212 disposed between the respective pairs.

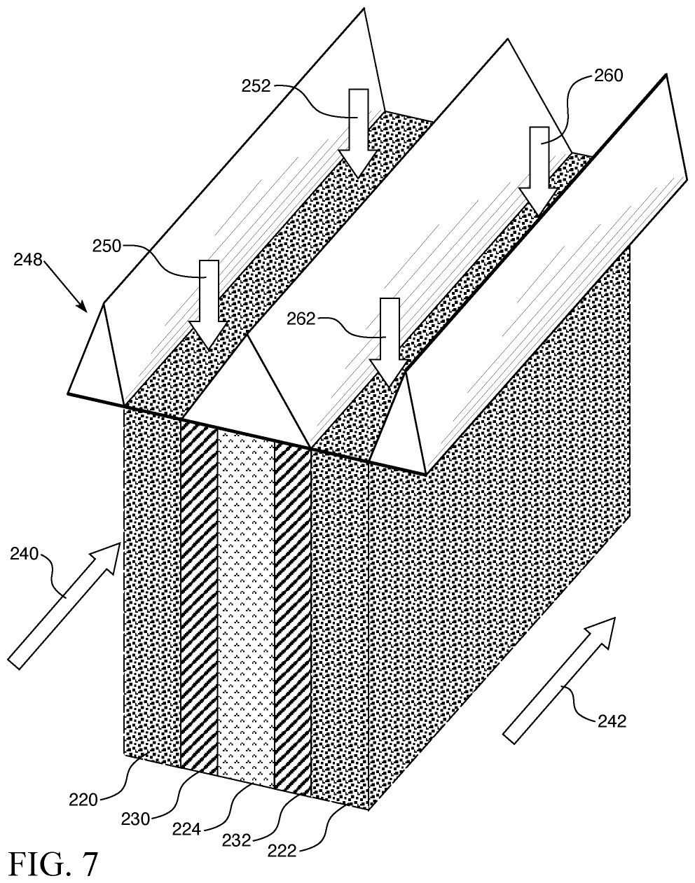

FIG. 7 shows a two-sided sacrificial anode wherein the structure has a pair of sacrificial anodes 220, 222, with an interposed cathode 224 and a pair of microporous separators 230, 232 between the cathode 224 and the respective anodes 220, 222. Overlying the two anodes 220, 222 is a fill hopper 248 with arrows 250, 252, 260 and 262 indicating the flow direction of the material being delivered to the anode 220, 222. Arrows 240 and 242 indicate the direction of water flow as it passes over the anodes.

Sacrificial anodes metal particulate can be fed from a continually filled hopper or can be sheet metal fed from a supply roller to a take-up roller.

Compared to the use of bleach being sprayed to control algae, electrochemical generation of hypochlorite this oxidant in a more manageable and controlled in localized areas.

Alternatively, the source of the feed could be sea water at the salinity of the vessel's marine environment. The electrogenerated aqueous hypochlorite solution is then dispersed in the K. brevis proliferation area, when analysis shows the K. brevis to be at low concentrations, on the incipient bloom area where the K. brevis is at higher concentrations, or on the bloom itself. Additives, for example, dyes, to delineate areas of treatment, or emulsifiers to spread red tide inhibitor more uniformly, can be added to the outflow of the leaking electrochemical cells. Activated carbons are also useful as additives to adsorb and minimize brevetoxins.

Depending on the application, electrolysis cell designs may include separators or ion exchange membranes to separate anode and cathode compartments as well as turbulence promoting internal structures. However, such separated electrochemical cell designs, in general, have a number of limitations, including separator and membrane fouling, buildup of deposits on cell parts and walls, and costly maintenance. The present invention avoids the use of ion exchange membranes in most applications, but does provide for separation of anodes and cathodes as well as turbulence flow promoters.

Under certain conditions, applying electrolysis, the K. brevis and its toxic byproducts are directly oxidized or reduced at the electrodes, thereby killing the K. brevis as well as destroying toxic byproducts, for example in the case of K. brevis, the brevetoxins. During electrolysis passivation or filming of electrodes may occur by deposition for example, of organic byproducts, causing an increase in ohmic resistance and loss of efficiency. Applying periodic current reversal or superimposed alternating current can effectively counter passivation and filming. Sensors can automate current reversal when needed.

Well-known to those skilled in the art are methods and equipment for electrochemical generation of hypochlorite solution for disinfection of saline water, for example, for swimming pools and for control of K. brevis growth in boiler water systems, to name only a few applications. Choice of appropriate electrically conductive anode materials that inhibit or minimize chlorine and hypochlorite production include but are not limited to anodes with high chlorine overpotential, including uncatalyzed titanium and niobium and alloys thereof, as well as various kinds of conductive carbons including graphite and diamond as well as conductive titanium oxides.

Anodes can also include slowly dissolving “sacrificial” metal anodes, such as steel, iron, copper, nickel, aluminum, magnesium, zinc, titanium and alloys thereof. Sacrificial anodes are useful in practicing the art for a number of reasons: avoiding or minimizing chlorine and hypochlorite generation, generation of the metal salt aiding red tide inhibition as the anode corrodes, and their relatively much lower cost compared to noble metal catalyzed anodes, such as Dimensionally Stable Anodes (“DSA's”). Sacrificial anode metals can be in sheet form, porous or non-porous and can be in the form of metal particulates such as shavings, dust, spheres, etc., fed continuously into a hopper connected electrically to the positive terminal of the DC power source and replenished as the metal in the hopper undergoes anodic corrosion.

Cathode materials include but are not limited to titanium, iron, nickel, aluminum, zinc, copper, metal alloys thereof and various conductive carbons.

An additional embodiment of the present invention is the use of electrolysis cell designs which purposefully have an open cell design or “leak”, thereby simplifying cell design, lowering cost and avoiding fouling issues while minimizing deposits. Zappi and Weinberg, U.S. Pat. No. 6,315,886, describes such cell designs and their uses. Accompanying drawings in this application depict a leaking cell design and a set of internal components. In the practice of this invention, in one example, a floating vessel such as a barge or ship is equipped with one or more leaking electrochemical cells, operating as the vessel moves and controls the proliferation of K. brevis.

A further embodiment of the present invention is the application of composite electrode materials consisting for example of metallic screens sandwiching a microporous separator. As an example, a composite sandwich can be constructed of titanium screen anodes and cathodes separated by an inert porous material such as polypropylene to keep the electrodes from shorting but maintaining a low ohmic resistance when in use in K. brevis infested waters. Direct current powered composites can be formed into sheets of various lengths and widths which can float on the water or dragged along the surface or deeper to kill the K. brevis.

Open or leaking electrochemical cell designs powered by a DC power source can be used for electrochemical generation of hypochlorite (bleach) solution from sea water, with the hypochlorite effluent then used to kill the K. brevis. Hypochlorite solution produced in this way should be at a low enough concentration sufficient to kill K. brevis, but insufficient to harm or kill fish and other wildlife.

Compared to the prior art where bleach solution is sprayed to control K. brevis, electrochemical generation of hypochlorite provides this oxidant in a more manageable localized space.

Alternatively, the source of the feed could be sea water at the salinity of the vessel's marine environment. The electrogenerated aqueous hypochlorite solution is then dispersed in the K. brevis proliferation area, when analysis shows the K. brevis to be at low concentrations, on the incipient bloom area where the K. brevis is at higher concentrations, or on the bloom itself. Additives, for example, dyes, to delineate areas of treatment, or emulsifiers to spread red tide inhibitors more uniformly, can be added to the outflow of the leaking electrochemical cells. Activated carbons are also useful as additives to adsorb and minimize brevetoxins.

An advantageous embodiment of the invention is to pass marine water infested with K. brevis through one or more leaking cell systems. Direct electrochemical control of K. brevis in this manner would also destroy toxic byproducts and other substances in the water, such as, for example brevetoxins, in the case of red tide. Appropriate choices of anode and cathode materials, current density and flow rate would be employed.

Anode materials may be non-porous; however, higher porosity anode materials can be used to increase the contact area for greater electrochemical efficiency. Such higher surface anode materials could be in the form of metal screens as well as in the form of conductive particles including metal filings and metal balls. In the case of sacrificial anode materials for example using iron filings, means would be provided in the cell design with a corrosion-stable metal or graphite connector to the filings and for continuous addition of fresh iron filings to the anode compartment as anodic corrosion proceeds.

Irrespective of the actual mechanisms of destruction of K. brevis and toxic byproducts, the appropriate choices of anode and cathode materials can cause direct oxidation of the K. brevis and the toxic byproducts at the anode, in situ destruction of these marine species, destruction by generation of trace hypochlorite, or generation of a powerful oxidizing agent such as peroxide, ozone or chlorate. Importantly, direct electrolysis of K. brevis laden sea water results in killing of the K. brevis and destruction of its toxic byproducts, such that the effluent from the leaking electrolysis equipment is made harmless to sea life.

Buildup on the electrodes of slimes as well as organic and inorganic deposits can be removed by periodic current reversal.

DC generators, solar cells, or rechargeable batteries could provide the necessary electricity to power the electrolysis equipment described hereinbefore.

The present disclosure provides:

1. A method of controlling red tide in a body of sea water comprising

providing the body of sea water to be treated, and

applying to said body of sea water a quantity of red tide inhibitor adequate to be effective in resisting growth of said red tide.

2. The method of paragraph 1 including

said red tide inhibitor is effective to resist creation of neurotoxins by said red tide.

3. The method of paragraph 1 including

employing as said red tide inhibitor sodium chloride solution.

4. The method of paragraph 1 including

in which said red tide inhibitor is employed by spreading at least one solid salt on the red tide selected from the group consisting of sodium chloride, rock salt, calcium oxide, calcium hydroxide, calcium carbonate and calcium sulfate.

5. The method of paragraph 1 including

employing said red tide inhibitor when said sea water is at a temperature of about 59° F. to 86° F.

6. The method of paragraph 1 including

by said method resisting blooming of said red tide.

7. The method of paragraph 1 including

employing symbiotic microorganisms generating signaling molecules which cause the red tide to cease proliferation.

8. The method of paragraph 1 including

distributing as said red tide inhibitor bacteria which will control the red tide.

9. The method of paragraph 1 including

employing as said red tide inhibitor an application of a solid absorbent for red tide neurotoxins.

10. The method of paragraph 9 including

in which said solid absorbent is selected from the group consisting of activated carbon and zeolites.

11. The method of paragraph 1 including

said red tide inhibitor includes a dye.

12. The method of paragraph 1 including

employing as said red tide inhibitor, a material selected from the group consisting of a concentrated saline solution or solid salt thereof.

13. The method of paragraph 1 including

employing as additives in treating said body of sea water at least one material selected from the group consisting of concentrated solutions of activated carbon, magnesium sulfate and copper sulfate.

14. The method of paragraph 1 including

said red tide inhibitor being tetramethylammonium chloride solution.

15. The method of paragraph 1 including

employing a method of electrolysis control of said red tide in a body of water, using an anode and a cathode contained in a leaking electrochemical cell.

16. The method of paragraph 15 including

said cells are connected to a DC power source.

17. The method of paragraph 15 including

said anode being a sacrificial anode.

18. The method of paragraph 15 including

said electrolysis cell is a composite consisting of an anode, a cathode and a thin film separator disposed therebetween.

19. The method of paragraph 15 including

wherein said cell is powered by an AC power source.

20. The method of paragraph 1 including

providing a floating vessel, having a plurality of electrolysis cells for receiving said body of sea water, and

treating said body of sea water.

21. The method of paragraph 20 including

said vessel is a vessel having said electrolysis cells operatively associated therewith, and

said vessel having power means for moving said vessel through said body of sea water.

22. The method of paragraph 20 including

said vessel being a floating barge.

23. The method of paragraph 20 including

introducing said sea water into said electrolysis cells and processing said sea water by treating it with said red tide inhibitor.

24. The method of paragraph 23 including

subsequent to said treating removing said processed sea water from said vessel.

25 The method of paragraph 20 including

establishing said flow of said body of sea water through said electrolysis cells to process the same and subsequently discharge the same and,

said flow of said sea water being effected, at least in part, through movement of said vessel.

26. The method of paragraph 20 including

employing open electrolysis cells as said electrolysis cells.

27. The method of paragraph 21 including

said vessel being a pontoon boat having a pair of pontoons, and

said electrolysis cells being secured to said vessel in a position disposed generally between said pontoons.

28. The method of paragraph 20 including

said vessel having a deck with said electrolysis cells secured to said deck.

29. The method of paragraph 20 including

said electrolysis cells having at least one anode, and

said anode being operated by DC power.

30. The method of paragraph 20 including

said vessel being a floating vessel which remains substantially stationary during processing of said sea water.

31. The method of paragraph 29 including

said anode having a dimensionally stable anode screen chosen from the group consisting of platinized titanium, ruthenium catalyzed titanium, graphite cloth and conductive titanium oxide.

32. The method of paragraph 29 including

said anode being a sacrificial anode screen chosen from the group consisting of copper, nickel, brass and zinc.

33. The method of paragraph 20 including

resisting undesired passivation and filming by periodically effecting current reversal or superimposed alternating current.

34. A floating vessel for processing red tide contained within a body of sea water to be treated comprising,

subsequently said floating vessel being structured to process red tide containing sea water in order to control the same, and

said floating vessel having a plurality of electrolysis cells, and

said vessel structured to have water flow through the vessel and be processed by red tide inhibitors, and subsequently to have the treated water discharged from the vessel.

35. The vessel of paragraph 34 including

said vessel structured to take in said sea water when the vessel is in motion.

36. The vessel of paragraph 34 including

said vessel being structured to have said sea water flow through said vessel under the influence of movement of said vessel.

37. The vessel of paragraph 34 including

said vessel being a floating barge which is structured to be stationery during said processing of said sea water by said electrolysis cells.

38. The vessel of paragraph 34 including

said electrolysis cells being open cells.

39. The vessel of paragraph 34 including

said vessel being a pontoon boat and said electrolysis cells being secured to said vessel in a position to be immersed in said body of sea water during treating of said sea water.

40. The vessel of paragraph 34 including

said vessel being a pontoon boat having a pair of relatively spaced pontoons, and a deck,

said pontoons secured to the underside thereof, and

said electrolysis cells being secured to said pontoon boat, and

said electrolysis cells being disposed in the space defined by the underside of the deck and between said vessel.

41. The vessel of paragraph 34 including

said electrolysis cells being structured to resist formation of red cell blooms and resultant toxic materials.

42. The vessel of paragraph 34 including

said apparatus being structured to be energized by AC current.

43. The method of claim 1 including providing a red tide concentration monitoring device.
44. The method of claim 43, wherein the amount of red tide inhibitor is automatically adjusted to the measured red tide concentration.

### EXAMPLES

Experiments were performed to determine the K. brevis count with various red tide inhibitors.

A microscope with magnification up to 2500 times, was used along with a gridded Sedgewick-Rafter counting slide to record K. brevis cell counts. Testing was performed on Gulf of Mexico sea water containing K. brevis with an initial K. brevis cell count of at least 1 million K. brevis cells per liter. Test tubes contained 10 ml. each of this sea water, to which the following salts and other chemicals were added. For a concentrated solution of the additive, one drop is added and for solid additives, 5 mg is added. The test tubes contents containing the additives were gently mixed and then counts tabulated after two minutes.

Table 1 identifies the additives tested and the resultant cell count.

TABLE 1

| Experiment | | |
|---|---|---|
| Number | Additive | Cell Count |
| 1 | Commercial bleach solution | None |
| 2 | Concentrated salt solution | None |
| 3 | Finely ground solid salt | None |
| 4 | Concentrated calcium sulfate solution | None |
| 5 | Concentrated magnesium sulfate solution | None |
| 6 | Concentrated copper sulfate solution | None |
| 7 | High surface area activated carbon | Very few |
| 8 | Household acetic acid (vinegar) | None |
| 9 | Solid calcium oxide | None |
| 10 | Dilute methylene blue solution | Very few |
| 11 | Combination of dye, activated carbon and | None |
| | finely ground salt crystals | |
| 12 | Combination of solutions of concentrated | None |
| | calcium sulfate and copper sulfate with | |
| | activated carbon | |

The above experiments illustrate the effectiveness of red tide inhibitors, the use of activated carbon and the application of combinations of additives.

An additional list of materials which can be used in red tide inhibition is shown in Table 2.

TABLE 2

| Additive | Explanation | Experimental Results* |
|---|---|---|
| Cold Water, 40° F. | Change temperature from normal range | No living K. brevis |
| | for sustainability of K. brevis | |
| Crushed Ice | Change temperature from normal range | No living K. brevis |
| | for sustainability of K. brevis | |
| Commercial bleach solution | Repeat literature results that bleach | No living K. brevis |
| | kills K. brevis | |
| Clay | Repeat literature results that clay | No living K. brevis |
| | removes or kills K. brevis | |
| Concentrated salt (NaCl) | Change salinity from normal range for | No living K. brevis |
| solution | sustainability of K. brevis | |
| Finely ground solid salt (NaCl) | Change salinity from normal range for | No living K. brevis |
| | sustainability of K. brevis | |
| Concentrated calcium sulfate | Test positively charged cationic | No living K. brevis |
| solution | additives | |
| Concentrated magnesium | Test positively charged cationic | No living K. brevis |
| sulfate solution | additives | |
| Concentrated copper sulfate | Repeat literature results that copper | No living K. brevis |
| solution | sulfate removes or kills K. brevis | |
| Concentrated sulfate salts of | Test positively charged cationic | No living K. brevis |
| iron and aluminum | additives | |
| High surface area activated | Test if activated carbon removes or | No living K. brevis |
| carbon | kills K. brevis; use of activated carbon | |
| | to absorb toxic substances | |
| Ground BioChar** solids | Test if BioChar removes or kills K. | No living K. brevis |
| | brevis | |
| Household vinegar (acetic acid) | Test change of solution pH | No living K. brevis |
| Concentrated sodium carbonate | Test change of solution pH | |
| solution | | |
| Concentrated lime solution | Test change of solution pH | No living K. brevis |
| (calcium hydroxide solution) | | |
| Concentrated calcium sulfate | Test positively charged cationic | No living K. brevis |
| solution | additives | |
| Concentrated methylammonium | Test cationic ammonium additives | No living K. brevis |
| chloride solution | | |
| Concentrated | Test cationic ammonium additives | No living K. brevis |
| tetamethylammonium chloride | | |
| solution | | |
| Dilute methylene blue dye | Test cationic organic dyes | No living K. brevis |
| solution | | |
| Combination of cationic dye, | Test combinations of additives | No living K. brevis |
| activated carbon and finely | | |
| ground of d salt crystals | | |
| Combination of solution of | Test combinations of additives | No living K. brevis |
| concentrated calcium sulfate | | |
| and activated carbon | | |

*Experimental Results, using microscopy and a microscope slide with a drop of Gulf of Mexico marine water containing at least hundreds of living K. brevis organisms to start. If the additive in solution form a droplet of the additive was added to the K. brevis containing droplet on the microscope slide. If the additive was in solid form, about 1 to 0 mg of the solid was added to the K. brevis containing droplet.
**BioChar is a charcoal-like form of carbon produced by pyrolysis of biomass in absence of oxygen.

Experimental results listed in Table 2 demonstrate that all these additives and combinations killed K. brevis.

A 250 ml single compartment electrolysis cell was used containing an anode, a cathode and Ag/AgCl reference electrode to measure the anode potential. A DC power supply along with a digital voltmeter and magnetic mixing were used. The electrolysis cell was filled with Gulf of Mexico water seeded with K. brevis such that a K. brevis cell count of at least 1 million per liter. In each case the cathode was a graphite rod and the anode materials included: graphite, copper, stainless steel, aluminum, zinc, platinized titanium and uncatalyzed titanium. Electrolysis was conducted for 10 minutes with gentle stirring.

Anodes of graphite, platinized titanium and uncatalyzed titanium evolved gas bubbles on polarization and the aqueous electrolyzate had the distinct odor of bleach. In contrast copper, aluminum and zinc anodes evolved no gas on polarization. These sacrificial anode metals exhibited some corrosion. The electrolyzate had a precipitate but had no evidence of hypochlorite formation by smell and by testing with hypochloritetest papers. Electrolysis tests were performed employing a composite in a leaky cell configuration.

(a) A titanium screen serving as the cathode in a tightly layered composite configuration is covered on both sides with a microporous polymer, with outer layers attached to the polymer of high surface area graphite cloth serving as the anode material. This composite cell is contained in a tube open at both ends. Electrical connection is made to a DC power supply and sea water containing K. brevis was pumped into a tube as electrolysis proceeded. Microscopic analysis of the effluent shows no K. brevis was present.
(b) The same composite electrolysis cell configuration and open-ended tubing was employed as in (a) above, except that the anode material was a sacrificial metal. Pumped into the leaky cell is sea water containing K. brevis. Electrolysis followed by microscopic analysis of the electrolyzate showed no K. brevis present.

### REFERENCES

1. Metabolic Interactions between Bacteria and Phytoplankton, X. Mayali, Front. Microbiol. (2018) 9, 727;
2. Algae-Bacterial Interactions, Evolution, Ecology and Emerging Applications, Rishiram et al, Biotechnology Advances, (2016) 34 (1) 14-29;
3. The effect of the algal microbiome on industrial production of microalgae, J. Lian et al, Microbial Biotechnology (2018) 11(5), 806-818;
4. Mitigation of harmful algal blooms using modified clays: Theory, mechanisms, and applications, Harmful Algae, Zhiming Yu et al, Elsevier, 69 (2017) 48-64;
5. Use of Ozone for Controlling Growth of Organisms, Cushman and Pierce, U.S. Pat. No. 6,984,330 B2 (2006);
6. Control of Harmful Algal Blooms By Induction of Programmed Cell Death, Paul and John, U.S. Pat. No. 8,476,196 B2 (2013);
7. Electrolytic Apparatus and Methods for Purification of Aqueous Solutions, Zappi and Weinberg, U.S. Pat. No. 6,315,886 B1 (2001);
8. Red Tide Organism Killer, Rigby, US Patent 2006/0159774 A1 (2006);
9. Compositions for the Control of Algae in Commercial Horticulture, Greaves U.S. Pat. No. 20,140,221,209A1 (2014);
10. Methods for the Remediation of Algal Blooms, Fuhrer and Fuhrer, U.S. Pat. No. 9,108,870 B2 (2015);
11. Ultrasonic Algae Control, Trigiani, U.S. Pat. No. 20,170,320,756 A1 (2017);
12. Electrochemistry for a Cleaner Environment, edited by Genders and Weinberg, (1992) by The Electrosynthesis Company, Inc., ISBN 0-9629708-1-6;
13. Technique of Electroorganic Synthesis, edited by Weinberg, Wiley Interscience, Part I (1974), Part II (1975), and Part III (1982);
14. Brevetoxins, see Wikipedia: en.wikipedia.org/wiki/Brevetoxin
15. Control of Harmful Algal Blooms By Induction of Programmed Cell Death, Paul and John, U.S. Pat. No. 8,476,196 B2 (2013);
16. Destruction of blue-green algae by microwave radiation, Olya Kovalevich, climatecolab.org/contests/2017/exploring-synergistic-solutions-for-sustainable-development/c/proposal/1334244

All publications and patents referred to herein are incorporated by reference. Various modifications and variations of the described subject matter will be apparent to those skilled in the art without departing from the scope and spirit of the invention. Although the invention has been described in connection with specific embodiments, it should be understood that the invention as claimed should not be unduly limited to these embodiments. Indeed, various modifications for carrying out the invention are obvious to those skilled in the art and are intended to be within the scope of the following claims.

What is claimed is:

1. A method of controlling red tide in a body of sea water comprising
providing the body of sea water to be treated, and
applying to said body of sea water a quantity of red tide inhibitor adequate to be effective in resisting growth of said red tide.

2. The method of claim 1 including
said red tide inhibitor is effective to resist creation of neurotoxins by said red tide.

3. The method of claim 1 including
employing as said red tide inhibitor sodium chloride solution.

4. The method of claim 1 including
in which said red tide inhibitor is employed by spreading at least one solid salt on the red tide selected from the group consisting of sodium chloride, rock salt, calcium oxide, calcium hydroxide, calcium carbonate and calcium sulfate.

5. The method of claim 1 including
in which said red tide inhibitor is employed by spreading on the red tide at least one of the group consisting of cold water and ice chips.

6. The method of claim 1 including
employing symbiotic microorganisms generating signaling molecules which cause the red tide to cease proliferation.

7. The method of claim 1 including
employing as said red tide inhibitor an application of a solid absorbent for red tide neurotoxins.

8. The method of claim 7 including
in which said solid absorbent is selected from the group consisting of activated carbon and zeolites.

9. The method of claim 1 including
said red tide inhibitor includes a dye.

10. A method of controlling red tide in a body of sea water comprising
providing the body of sea water to be treated, and
applying means to electrolyze said body of seawater employing electrolysis cells comprising an anode and a cathode in a leaking electrochemical cell.

11. The method of claim 10 including
said cells are connected to a DC power source.

12. The method of claim 10 including
said anode being a sacrificial anode.

13. The method of claim 10 including
said electrolysis cell is a composite consisting of an anode, a cathode and a thin film separator disposed therebetween.

14. The method of claim 1 including
providing a floating vessel, having a plurality of electrolysis cells for receiving said body of sea water, and
treating said body of sea water.

15. The method of claim 14 including
employing open electrolysis cells as said electrolysis cells.

16. The method of claim 10 including
said anode having a dimensionally stable anode screen chosen from the group consisting of platinized titanium, ruthenium catalyzed titanium, graphite cloth and conductive titanium oxide.

17. The method of claim 10 including
said anode being a sacrificial anode screen chosen from the group consisting of copper, nickel, brass and zinc.

18. The method of claim 10 including
resisting undesired passivation and filming by periodically effecting current reversal by employing alternating current.

19. The method of claim 1 including providing a red tide concentration monitoring device.

20. A floating vessel for processing red tide contained within a body of sea water to be treated comprising,
subsequently said floating vessel being structured to process red tide containing sea water in order to control the same, and
said floating vessel having a plurality of electrolysis cells, and
said vessel structured to have water flow through the vessel and be processed by red tide inhibitors, and subsequently to have the treated water discharged from the vessel.
